(19) United States
(12) Patent Application Publication
(10) Pub. No.: US 2004/0074685 A1
(43) Pub. Date: Apr. 22, 2004

(54) Magnetic sensor for an automated guided vehicle system

(76) Inventor: Yew Keong Tham, Blk (SG)

Correspondence Address: TESTA, HURWITZ & THIBEAULT, LLP, HIGH STREET TOWER, 125 HIGH STREET, BOSTON, MA, 02110, US

(21) Appl. No.: 10/467,486

(22) PCT Filed: Feb. 12, 2001
(86) PCT No.: PCT/SG01/00018

(51) Int. Cl. B62D 1/24

(52) U.S. Cl. 180/168

(57) ABSTRACT

A magnetic field sensor for an automated guided vehicle is disclosed which includes a magnetisable rod (62) located in proximity to sensor element (60) so that the rod (62) becomes magnetised to create a secondary magnetic field which is detected by the sensor element (60) to thereby increase the localised magnetic flux density produced by a magnet located in the roadway. The sensor also includes a power switching circuit (90, 93) which selectively powers on and off the sensor element (60) to perform a power reset to the sensor element (60) to eliminate hysteresis within the element (60). The sensor (60) is preferably included in an array which comprises a central section having sensor element (60) spaced by a first distance and side section on each side section on each side of the central section in which the sensor elements (60) are spaced apart by a second distance larger than the first distance.

### FIELD OF THE INVENTION

This invention relates to a magnetic field sensor for an automated guided vehicle system and to a guided vehicle system including the magnetic field sensor.

### DESCRIPTION OF THE PRIOR ART

Automated guided vehicle systems are known which employ a grid or line of magnets along or upon a path which a vehicle is to traverse. The vehicle carries a magnetic field sensor for sensing the magnets so that information can be obtained to enable guiding of the vehicle relative to the magnets.

The conventional systems utilise a wide variation in the types of sensors used, and techniques used range from measurements of 3-D magnetic field strengths of the magnet using magnetometers to a simple, single row of magnetic sensors to detect the position of the magnet. Each technique has its associated strengths or limitations, and the techniques used depend on the requirements of the application such as speed of the vehicle, separation between sensor and magnet and accuracy.

Magnetic sensors which include magnetic sensor switches are normally used in conjunction with magnets which are fixed in a roadway and which define a path along which a vehicle is to traverse. By sensing the magnetic field strength information as to the position of the vehicle relative to the magnets can be determined and the steering of the vehicle can be controlled so that the vehicle follows the magnets as it drives from one place to another.

Magnetic sensor switches with a digital output signal line are commonly used to detect the presence of magnets which are placed close to the sensor. As such, they are produced with high operating thresholds with the intention of near field detection. In view of this, for applications that require far-field detection, relatively large magnets of about 100 mm in diameter and 75 mm in thickness are necessary to increase the localised magnetic field strength. This size magnet provides a sensor to magnet distance of only about 22 cm. That is, in order for the sensor to detect. the magnetic field from the magnet the sensor should be no more than 22 cm from the magnet when the sensor passes over the magnet.

As such, most magnet guidance systems find application in the tracking of vehicles used in an indoor, factory environment where the vertical deflection of the vehicle is small. The sensor can be kept at close and deterministic height from the ground magnets. Such systems are also used in heavy duty industries such as steel mills. However, in these applications the speed of the moving vehicle is relatively slow at approximately two meters per second. Thus, the dynamic vertical deflection of the vehicle (and also the sensor carried by the vehicle) during motion is well within the detection limits.

However, such systems therefore do not have great application outside of these environments and in particular in environments where the vehicle may undergo substantial load variations of up to sixty tons, such as in environments where the vehicle is being used to transport shipping containers from one place after they are unloaded from a ship, to another place for loading onto a road vehicle. Such automatically guided vehicles run on pneumatic tyres and have a maximum straight travelling speed of seven meters per second and turning and parallel change lane speeds of three meters per second. As such, substantial variations in the distance or height of the vehicle from the roadway will take place as the vehicle is loaded and unloaded and during motion. Furthermore, if the system is used in an environment where ensuring of foreign objects free from the ground is not possible, damage to the sensor can occur if the sensor is mounted to low. This, therefore imposes a certain minimum separation between the sensor and ground.

Furthermore, in this environment the amount of room in which a magnet can be embedded in a roadway is restricted because of the use of reinforcement bars within the concrete roadway upon which the vehicle travels. For instance, reinforcement bars may be located 70 mm beneath the surface of the roadway thereby limiting the size of hole which can easily be produced in which a magnet can be located to provide a mark for automatically guided vehicles.

A second problem associated with conventional systems that uses magnetic sensor switches with digital output relates to the phenomenon of hysteresis. This problem occurs because the operating and release points of the magnetic sensor switch are different by nature of their design and construction. As the sensor leaves the magnet, the magnetic sensor switches remain switched on until the magnetic flux level drops below the release point of the sensor, which is much lower than the operating point of the sensor. Thus, the computed position of the magnet appears as a “lag” behind the physical position of the magnet due to the memory effect or hysteresis. This results in inaccurate estimates of the magnets position. The detection accuracy of the position of a magnet is extremely important in the transfer of shipping containers from one place to another in a dock environment because the vehicle is expected to stop (without the assistance from any other sensors) within 5 cm at the destination point for loading and unloading operations.

### SUMMARY OF THE INVENTION

The object of a first aspect of the invention is to overcome the first problem mentioned above which concerns the sensor to magnet distance.

This aspect of the invention may be said to reside in a magnetic field sensor assembly for sensing a magnetic field created by a magnet, the sensor assembly including;

at least one sensor having a sensor element; and

a magnetisable member located adjacent the sensor element and between the sensor element and the magnet when the sensor is in use, and wherein, in use, the member becomes magnetised by the magnetic field produced by the magnet to create a secondary magnetic field which is detected by the sensor element to thereby boost or increase the localised magnetic flux density produced by the magnet.

According to this aspect of the invention, the member, in the presence of an external applied magnetic field from the magnets, induce magnetism and become temporary magnets. Because the member has a material permeability higher than air and is adjacent to the sensor element the magnetic field produced by the member can be detected by the sensor lements whereas, without the use of the member, the magnetic field, if the sensor to magnet distance is sufficiently large, may be too small to trigger the sensor element. Therefore, the operating point of the magnetic sensor remains unchanged and the sensor to magnet distance can be greatly extended. In other words, a small external magnetic field strength is all that is necessary in order to activate the sensors because that small field strength will induce a magnetism within the members when the sensor passes over a magnet and that magnetic field will be detected by the sensor element to produce an output from the sensor element indicative of the magnet.

Preferably the member is a cylindrical rod shaped member having a longitudinal axis which is aligned, in use, in the direction of a line extending between the magnet and the sensor when the sensor passes the magnet.

Preferably the member is a ferromagnetic member.

Preferably the member is formed from manganese zinc ferrite material having the general formula MnZn.Fe₂O₃.

Preferably the member is impinged against the sensor element.

Preferably the member has a diameter of about 8 mm and a length of about 40 mm and an initial permeability of 2000.

Preferably the sensor element is mounted on a sensor board and the member is located in a member holder, a spring being located in the member holder for biasing the member so that it impinges against the sensor element.

Preferably the member holder is coupled to a holder plate, the holder plate having a screw threaded hole and the member holder having a screw thread for engagement in the screw threaded hole, the sensor board being located adjacent to the holder plate so that the sensor element projects through the screw threaded hole and into the member holder.

Preferably the member holder has a base and the spring is disposed between the base and the member for biasing the member against the sensor element.

The member holder may have a circumferential flange for engaging a surface of the member plate for limiting the amount of insertion of the member holder into the screw threaded hole when the member holder is screw threaded into the screw threaded hole in the member plate.

Preferably the sensor comprises a plurality of said sensor elements and said magnetisable members.

The invention may also be said to reside in an automated guided vehicle system, including;

at least one automated guided vehicle, the automated guided vehicle having a sensor assembly having at least one sensor, the sensor including a plurality of sensor elements each sensor element having a magnetisable member located adjacent the sensor element;

a plurality of magnets arranged along a roadway which is to be traversed by the vehicle for guiding movement of the vehicle along the roadway;

each sensor element having the magnetisable member located adjacent the sensor element so as to be between the sensor element and the magnets when the vehicle passes over the magnets; and

wherein when the vehicle passes over the magnets the member becomes magnetised by the magnetic field produced by the magnets to create a secondary magnetic field which is detected by the sensor element to thereby boost or increase the localised magnetic flux density produced by the magnets.

Preferably the member is a cylindrical rod shaped member having a longitudinal axis which is aligned, in use, in the direction of a line extending between the magnets and the sensor when the sensor passes over the magnet.

Preferably the magnetisable member is a ferromagnetic member.

Preferably the member is formed from manganese zinc ferrite material having the general formula MnZn.Fe₂O₃.

Preferably the member is impinged against the sensing element.

Preferably the member has a diameter of about 8 mm and a length of about 40 mm and an initial permeability of 2000.

Preferably the sensor element is mounted on a sensor board and the member is located in a member holder, a spring being located in the member holder for biasing the member so that it impinges against the sensor element.

Preferably the member holder is coupled to a holder plate, the holder plate having a screw threaded hole and the member holder having a screw thread for engagement in the screw threaded hole, the sensor board being located adjacent to the holder plate so that the sensor element projects through the screw threaded hole and into the member holder.

Preferably the member holder has a base and the spring is disposed between the base and the member for biasing the member against the sensor element.

Preferably the magnets are ceramic-ferrite magnets of cylindrical shape and have a diameter of about 100 mm and a thickness of about 50 mm.

The object of a second aspect of the invention is to overcome the problem associated with hysteresis due to the different operate and release points of the sensor.

This aspect of the invention provides a magnetic field sensor assembly sensing a magnetic field created by a magnet for the sensor assembly including;

at least one sensor element for detecting the magnetic field produced by the magnet; and

power switching means for selectively switching the sensor elements between a power on level and a power off level.

According to this aspect of the invention because the sensor elements are switched between the power on and power off level an effective power reset to the sensor occurs so that the operation of the sensor element only depends on the operation point of the sensor, that is the magnetic gauss level to activate the sensor element. The release point of the sensor is immaterial in the operation of the sensor element. By relying on a single triggering point for the sensor, the phenomenon of hysteresis that causes inaccuracies in measurements as the sensor passes over the magnet is totally eliminated.

Preferably the power switch means comprises a transistor and switching control means for switching the transistor on and off, the transistor having a collector which is connected to the sensor element and an emitter which is connected to ground, the switching control means being connected to the base of the transistor so that when a power on signal is applied to the base the sensor element is connected to ground through the transistor and the sensor element is activated or powered up since potential can be applied across the sensor element between the ground created by the transistor and a sensor power supply to the sensor element, and when the switching control means switches off the transistor is switched off to disconnect the sensor element from ground so that there is no potential difference across the sensor element and the sensor element is powered off.

Preferably the switching control means switches the sensor elements on and off periodically by supplying high and low signals to the base of the transistor.

Preferably the sensors are powered on for about 2 ms and then powered off and so on. Preferably the sensors are read after each 2 ms power on period and after being read are then powered off for at least 1 ms before the next power on period.

Preferably the sensor power supply comprises a fixed voltage supplied to the sensor elements.

Preferably each sensor element has a ferromagnetic member located adjacent the sensor element for boosting or increasing a localised magnetic flux density produced by the magnets.

This aspect of the invention may also be said to reside in an automated guided vehicle system, including;

at least one vehicle including a magnetic field sensor assembly having at least one sensor element;

a plurality of magnets located along a roadway for guiding movement of the vehicle relative to the magnets; and

power switching means for periodically switching power on and off to the at least one sensor element.

Preferably the power switching means comprises a transistor and switching control means for switching the transistor on and off, the transistor having a collector which is connected to the sensor element and an emitter which is connected to ground, the switching control means being connected to the base of the transistor so that when a power on signal is applied to the base the sensor element is connected to ground through the transistor and the sensor element is activated or powered up since potential can be applied across the sensor element between the ground created by the transistor and a sensor power supply to the sensor element, and when the switching control means switches off the transistor, the transistor is switched off to disconnect the sensor element from ground so that there is no potential difference across the sensor element and the sensor element is powered off.

Preferably the power supply to the sensor elements is switched on and off periodically by supplying high and low signals to the base of the transistor.

Preferably the switching sensors are powered on for about 2 ms, then read, and then powered off for at least 1 ms and then powered on again for 2 ms and so on.

Preferably the sensor power supply comprises a fixed voltage supplied to the sensor elements.

Preferably each sensor element has a ferromagnetic member located adjacent the sensor element for boosting or increasing a localised magnetic field strength produced by the magnets.

This aspect of the invention may also be said to reside in a sensor assembly for detecting a magnetic field produced by a magnet, including;

at least one sensor element having first and second power pins and an output pin;

a sensor power supply for supplying power to the first pin of the at least one sensor element, the second pin of the at least one sensor element being coupleable to a reference potential so that power is supplied to the at least on sensor element for powering the at least one sensor element;

switching means for selectively powering on or off the at least one sensor element; and

a switching control means for providing a pulsed control signal to the switching means to cause the switching means to intermittently switching power on and off to the at least one sensor element to perform a power reset to the at least one sensor element to eliminate hysteresis within the at least one sensor element.

Preferably the switching means comprises a transistor having a base, a collector and an emitter, the collector being connected to the second pin, the emitter being connected to the reference potential and the base being connected to the switching control means.

Preferably the reference potential is ground.

Preferably the switching control means supplies a pulse signal having a high signal for switching the transistor on and therefore connecting the second pin to the reference potential for a period of about 2 ms, and a low signal for switching the transistor off and therefore disconnecting the second pin from the reference potential.

Preferably the sensor element has a magnetisable member adjacent the sensor element which becomes magnetised by a magnetic field produced by the magnet to increase the localised magnetic field strength for detection by the at least one sensor element.

This aspect of the invention may also be said to reside in an automated vehicle guidance system for automatically guiding a vehicle relative to a plurality of magnets, said system including;

at least one vehicle including at least one magnetic field sensor assembly;

a plurality of magnets arranged along a roadway which the vehicle is to traverse;

the sensor assembly having;

at least one sensor element having first and second power pins and an output pin;

a sensor power supply for supplying power to the first pin of the at least one sensor element, the second pin of the at least one sensor element being coupleable to a reference potential so that power is supplied to the at least on sensor element for powering the at least one sensor element;

switching means for selectively power on or off the at least one sensor element; and

a switching control means for providing a pulsed control signal to the switching means to cause the switching means to intermittently switch power on and off to the at least one sensor element to perform a power reset to the at least one sensor element to eliminate hysteresis within the at least one sensor element.

Preferably the switching means comprises a transistor having a base, a collector and an emitter, the collector being connected to the second pin, the emitter being connected to the reference potential and the base being connected to the switching control means.

Preferably the reference potential is ground.

Preferably the switching control means supplies a pulse signal having a high signal for switching the transistor on and therefore connecting the second pin to the reference potential for a period of about 2 ms, and a low signal for switching the transistor off and therefore disconnecting the second pin from the reference potential.

Preferably the sensor element has a magnetisable member adjacent the sensor element which becomes magnetised by a magnetic field produced by the magnet to increase the localised magnetic field strength for detection by the at least one sensor element.

A further aspect of the invention may be said to reside in a magnetic field sensor assembly for detecting a magnetic field created by a magnet, the sensor assembly including;

at least one central sensor array, the central sensor array having a plurality of sensors spaced apart by a predetermined first distance; and

a first side sensor array and a second side sensor array arranged on each side of the central sensor array so as to sandwich the central sensor array therebetween, the first and second side sensor arrays each having a plurality of sensors spaced apart by a second predetermined distance which is greater than the first predetermined distance.

Thus, according to this aspect of the invention, during normal straight driving of the vehicle it is expected that the magnets are located, most of the time, within the central array. With the smaller separation between the sensor elements in the sensor array improved accuracy can be obtained. The first and second side sensor boards are useful during turn manoeuvres where the magnet markers can appear on either side of the central sensor array and with a greater spacing in the first and second side sensor arrays a wider search envelope at the expense of a slightly lower accuracy is created. This aspect of the invention thereby provides a minimum number of sensor elements in the sensor because the greater spacer in the side sensor array thereby reducing the number of sensor elements required whilst at the same time ensuring a wider search envelope by the first and second side sensor arrays during turning movement of the vehicle.

Preferably the central sensor array comprises a first central sensor array and a second central sensor array.

Preferably the first and second sensor arrays each comprise nine rows and eight columns of magnetic sensor elements.

Preferably the first and second side sensor array also each comprise nine rows and eight columns of magnetic sensor elements.

Preferably each of the sensor arrays are coupled to a processor board for receiving output signals from each sensor array to enable the position of a vehicle to be determined relative to the magnets.

Preferably the processor board is coupleable to a navigation system for determining the position of a vehicle relative to the magnets and for producing control signals for controlling movement of the vehicle in response to the position signals.

Preferably the sensors each comprise a sensor element and a magnetisable member adjacent the sensor element.

This aspect of the invention may also be said to reside in an automated guided vehicle system, including;

at least one vehicle including a sensor assembly;

a plurality of magnets located along a roadway for detection by the sensor to enable the vehicle to be automatically guided relative to the magnets; and

wherein the sensor assembly comprises at least one central sensor array, the central sensor array having a plurality of sensor elements spaced apart by a predetermined first distance, and a first side sensor array and a second side sensor array arranged on each side of the central sensor array so as to sandwich the central sensor array therebetween, the first and second side sensor arrays each having a plurality of sensors spaced apart by a second predetermined distance which is greater than the first predetermined distance.

Preferably the central sensor array comprises a first central sensor array and a second central sensor array.

Preferably the first and second sensor arrays each comprise nine rows and eight columns of magnetic sensor elements.

Preferably the first and second side sensor array also each comprise nine rows and eight columns of magnetic sensor elements.

Preferably each of the sensor arrays are coupled to a processor board for receiving output signals from each sensor array to enable the position of a vehicle to be determined relative to the magnets.

Preferably the processor board is coupleable to a navigation system for determining the position of a vehicle relative to the magnets and for producing control signals for controlling movement of the vehicle in response to the position signals.

Preferably the sensors each comprise a sensor element and a magnetisable member adjacent the sensor element.

### BRIEF DESCRIPTION OF THE DRAWINGS

A preferred embodiment of the invention will be described, by way of example, with reference to the accompanying drawings in which;

FIG. 1 is a schematic diagram of the underneath of a vehicle and showing magnets embodying the invention;

FIG. 2 is a diagram illustrating overall operation of a guidance system according to the preferred embodiment of the invention;

FIG. 3 is a schematic view of a sensor assembly according to the preferred embodiment of the invention;

FIG. 4 is a schematic view of a sensor used in the sensor assembly of the preferred embodiment and also a magnet for producing the magnetic field which is detected by the sensor;

FIG. 5 is a graph showing relationship between size of a magnetisable member used in the sensor of the preferred embodiment and slug permeability;

FIG. 6 is an exploded view of a sensor used in the sensor assembly;

FIG. 7 is an assembled view of the sensor of FIG. 6;

FIG. 8 is circuit diagram showing sensors according to the preferred embodiment of the invention;

FIG. 8A is an alternative embodiment to that shown in FIG. 8;

FIG. 9 is a flow chart showing operation of the circuit of FIG. 8;

FIG. 10 is a block circuit diagram showing the magnetic sensor module including the sensor assembly of the preferred embodiment;

FIG. 11 is a flow chart displaying operation of the detection algorithm according to the preferred embodiment of the invention; and

FIGS. 12, 13 and FIG. 14 are diagrams illustrating magnetic field detection with magnets at different positions of the sensor coverage.

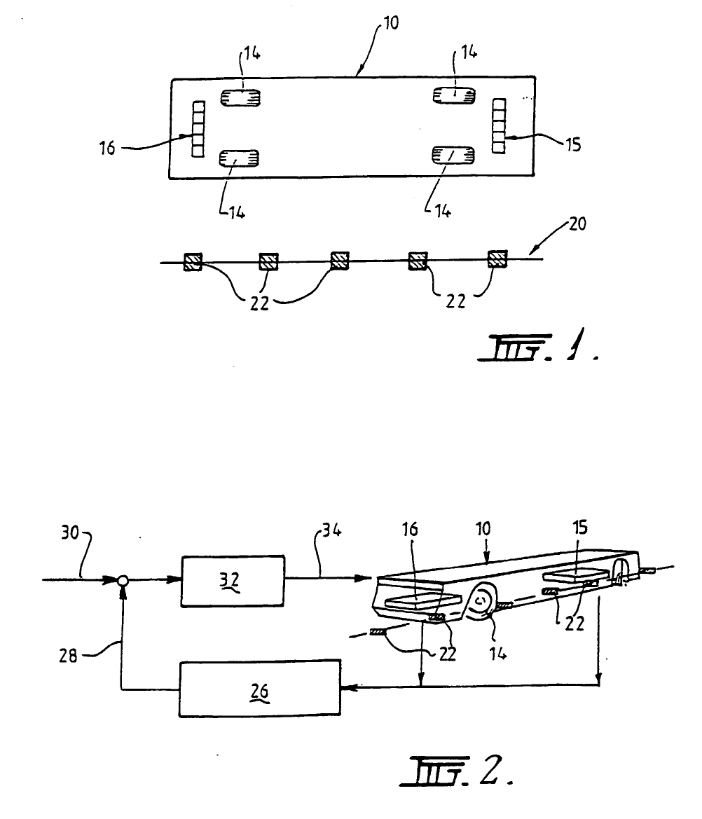

With reference to FIG. 1 a schematic diagram of a vehicle and roadway marked by magnets is shown which has application to the transport of shipping containers in a dockland environment from one location where the containers are loaded onto or from a ship, to another location where the shipping containers may be stored for collection by road transport or directly loaded onto load transport vehicles.

FIG. 1 shows an underneath view of a vehicle 10 which has wheels 14. A first sensor assembly 15 is arranged at the front of the vehicle and a second sensor assembly 16 is arranged at the rear of the vehicle. The sensor assemblies 15 and 16 will be described in more detail hereinafter.

A roadway 20 along which the vehicle 10 is to move has magnets 22 embedded within its surface. The magnets 22 are typically cylindrical in configuration but are shown square in FIG. 1 simply for ease of illustration.

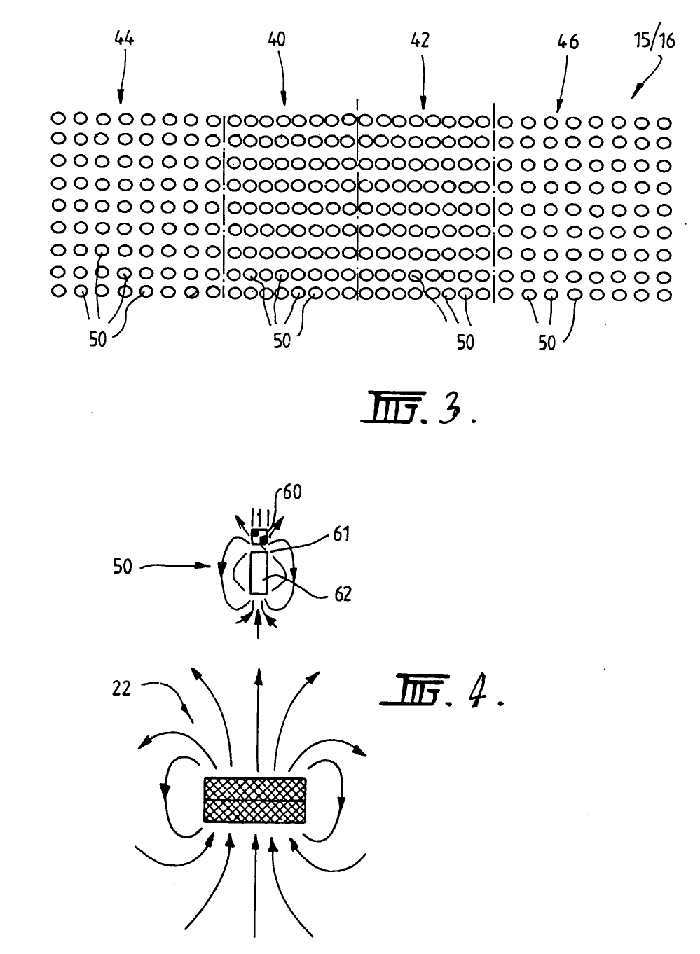

With reference to FIG. 2, when the vehicle is driven along the roadway over the magnets 22 the sensor assemblies 15 and 16 output detector signals indicative of detection of the magnets 22 to position estimator 26. The position estimator 26 calculates the position of the vehicle relative to the magnets 22 in accordance with a known algorithm and outputs a position signal on line 28 which is combined with a destination signal 30 from a control computer (not shown) to provide a driver control signal to driver controller 32. The driver controller signal 32 outputs speed, and front and rear wheel steering commands an line 34 to the vehicle 10 to control the speed of the vehicle and also turning of the vehicle via wheels 14 so that the vehicle 10 is automatically guided along the roadway relative to the magnets 22 from one place to another.

The sensor assemblies 15 and 16 are identical in configuration and are shown schematically in FIG. 3. The sensor assemblies 15 and 16 comprise a middle left sensor array 40 a middle right sensor array 42 a left. side sensor array 44 and a right side sensor array 46. Each sensor array 40-46 includes sensors 50. The sensors 50 in the middle arrays 40 and 42 are spaced apart by a distance of 3 cm in the x-direction and 5 cm in the y-direction and comprise nine rows and eight columns of sensors making seventy-two sensors in each array 40 and 42. The left and right hand sensor arrays 44 and 46 also have nine rows and eight columns making up seventy-two sensors each but the sensors 50 in the arrays 44 and 46 are spaced apart by a distance of 5 cm in both the x and y directions.

The greater density of sensors in the middle arrays 40 and 42 improves accuracy because when driving in a straight line, it will be expected that the magnets 22 will be located beneath the middle arrays 40 and 42 most of the time. With a smaller separation between sensors in these arrays, accuracy is improved. On the other hand, the side sensors arrays 44 and 46 are useful during turning manoeuvres where the magnets 22 can appear on either side of the middle sensor arrays 40 and 42. The two side sensor arrays 44 and 46 offer a wider search envelope at the expense of a slightly lower accuracy because of the greater spacing of the sensors. Nevertheless, the arrangement of the sensors shown in FIG. 3 provides high accuracy in view of the density of sensors in the middle arrays where most of the sensing will take place and a large sensing envelope by virtue of the increased spacing of the sensors in the left and right arrays 44 and 46 so as to provide a sensor which has both accuracy and a wide search envelope for detecting the magnets 22 during manoeuvring of a vehicle.

The arrangement of the sensors in the sensor assemblies 15 and 16 in a two dimensional array allows the system to pinpoint the exact x, y position of a marker magnet within the sensing zone. The size of the two dimensional array depends on the intended coverage of the application. In the preferred embodiment of the invention the length of the arrays 40 and 42 in the x direction is 21 cm and length of the arrays 44 and 46 in the x direction is 35 cm. The length Of the arrays 40, 42, 44 and 46 in the y direction is 40 cm.

The separation between the sensors 50 is selected to achieve the desired accuracy in the position measurements. The expected error in each measurement is equivalent to half the sensor separation and conforms to a uniform distribution function.

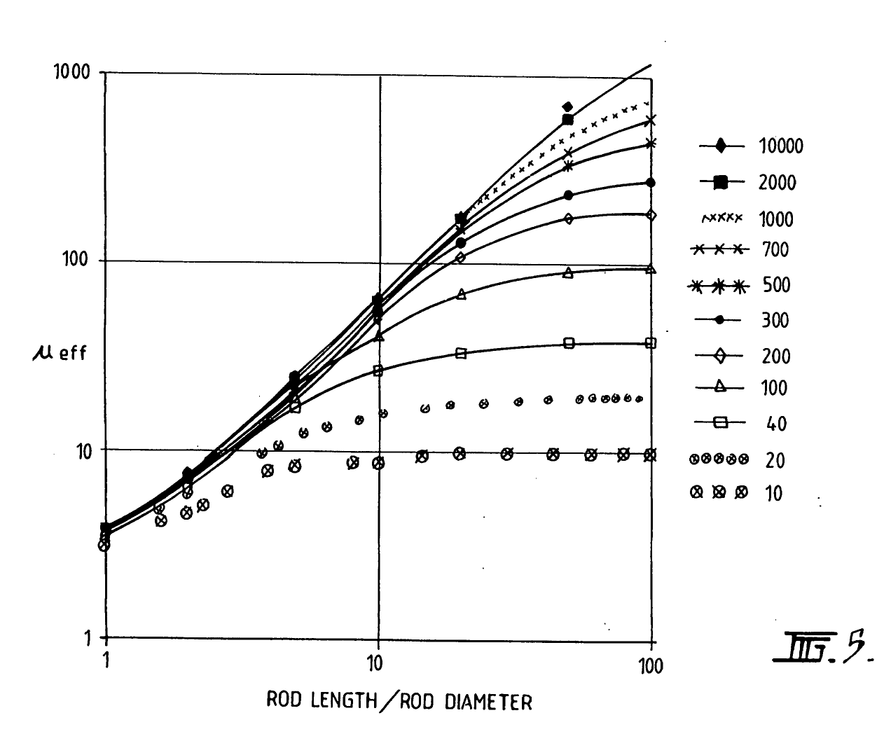

As is best shown in FIG. 4 the sensors 50 comprise a sensor element 60 which is most preferably a magnetic sensor switch, for example, a solid-state magnetic sensor (2SS52M) made by Honeywell. Arranged adjacent the sensor element 60 is a soft ferromagnetic member 62 which is located between the sensor 50 and the magnet 22 to act as an intermediate booster to increase the localised magnetic field strength. The member 62 is preferably formed from a manganese zinc ferrite which is a ceramic material with the general chemical formula MnZn.Fe₂O₃. These soft magnetic materials are easily magnetised and demagnetised because of their relatively high permeability and very narrow hysteresis loop.

The member 62 is preferably configured as a cylindrical rod having a diameter of about 8 mm and a length of about 40 mm and impinges against the sensing face 61 of the sensor element 60 as will be described in more detail with reference to FIG. 6.

In the presence of an external applied magnetic field such as that supplied by the magnets 22, the rods 62 induce a magnetism and become temporary magnets. As the rods 62 have a high material permeability, the build up of magnetic flux density with the ferrite rods 62 is extremely large. By pressing the rods 62 against the sensing face 61 of the sensor elements 60, the overall systems needs only a sufficiently small external magnetic field strength to activate the sensor elements 60. Thus, the operating point of the magnetic sensor remains unchanged from the point of view of the amount of magnetic field required, but the sensor to magnetic distance is effectively extended because of the amplifying effect the rod has in respect of the magnetic field produced by the magnets 22. Testing has shown that using the abovementioned magnetic sensor element the conventional maximum sensor to magnet separation distance in order to enable the magnetic sensor to operate and properly indicate the proximity of the magnets 22 is 18 cm. With the present invention using the ferrite rod 62 mentioned above which is impinged against the face 61 of the sensing element 60, the distance can be extended to 31 cm. Furthermore, the size of the magnets 22 can be maintained relatively small so that they can be easily embedded in the roadway. In the preferred embodiment of the invention the magnets 22 are ceramic ferrite magnets of cylindrical shape having a diameter of about 100 mm and a length of about 50 mm. The magnets of this dimension can be readily embedded into the roadway without interfering with reinforcing structure such as reinforcement bars which are embedded in a roadway to strengthen the roadway.

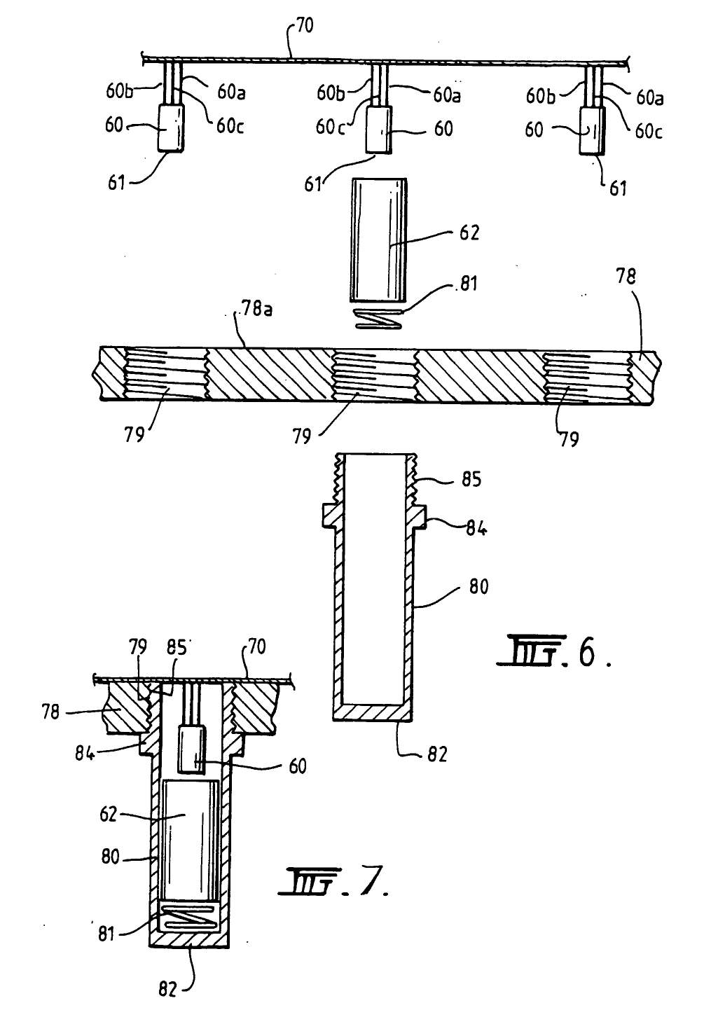

The effective permeability of the rod 62 plays an extremely important role in determining the sensor to magnet distance. The permeability is the function of the length to diameter ratio, as well as the material initial permeability. FIG. 5 shows a graph which gives the permeability of the rod 50 versus the length divided by the rod diameter for a number of initial permeabilities. Thus, by changing the mechanical dimensions the effective permeability of the ferrite rod can be selected to suit the environment in which the sensor is to be used.

FIG. 6 shows the sensors 50 in more detail. The sensors 5O are mounted on a sensor board 70 which may form a single board on which each of the arrays 40, 42, 44 and 46 previously described with reference to FIG. 3 are formed. Three sensor elements 60 are shown in FIG. 6 but as previously described, each sensor array and therefore each of the boards 70 will carry seventy-two sensor elements which, will make up the seventy-two sensors 50 previously described. Each of the sensor elements 60 has three pins 60a, 60b and 60c as shown in FIG. 6. The pins 60a and 60b can be the power supply pins and pin 60c can be an output pin for supplying an output indicative of a sense magnetic field.

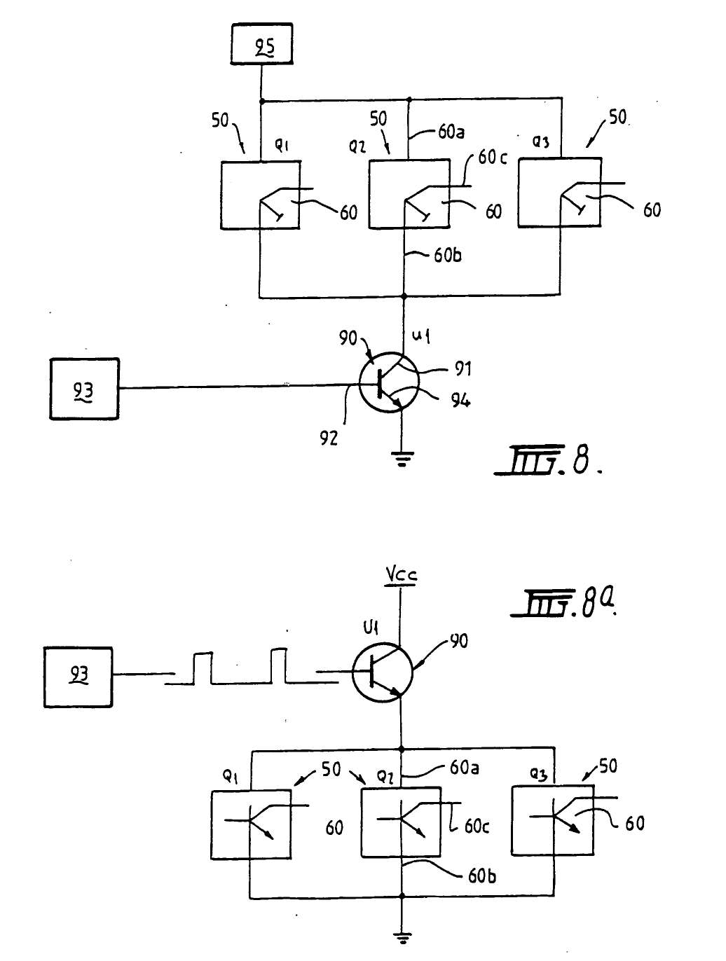

In order to assemble the sensor arrays 42 and 44 the sensor board 70 is bolted to a holder plate 78. The holder plate 78 has screw threaded holes 79 which register with the sensor elements 60 so that the sensor elements 60 can project through the holes 79. A rod holder 80 is provided and is of generally cylindrical form. The holder 80 has a base 82 and a circumferential flange 84. The portion 85 of the holder 80 above the flange 84 is screw threaded so that the holder 80 can screw threaded into the hole 79 to attached the holders 80 to the plates 78 with the flange 84 limiting the amount of insertion of the portion 85 into the hole 79 so that the top of the portion 85 is generally flush with the upper surface 78a of the plate 78 as shown in the assembled drawing forming FIG. 7.

A spring 81 is located between the rod 62 and the base 82 of the holder 80 so that when the rod 62 is located within the holder 80 the spring 81 biases the rod 62 up against the sensing surface 61 of the sensor element 60. It should be noted in FIG. 7 a slight space is shown between the sensor element 60 and the rod 62 and also between the rod 62 and the spring 81 simply for illustrative purposes.

Thus, each of the sensor elements 60 has a rod 62 impinging against its sensing surface 61 by the action of the spring 81.

In accordance with the preferred embodiment of the invention problems associated with hysteresis which occurs in every magnetic sensor where the operating and release points are different is addressed.

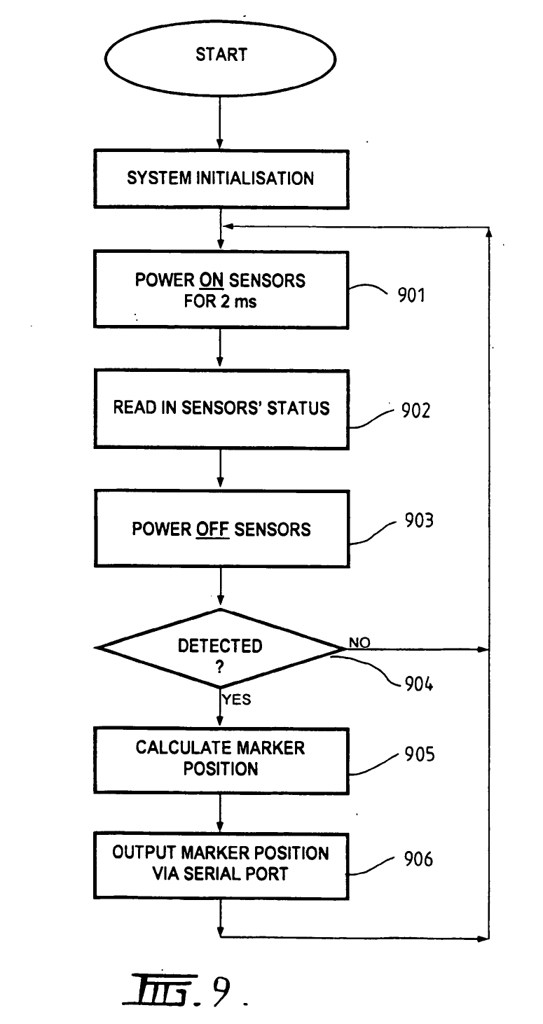

In order to overcome the problem of hysteresis, the hysteresis is totally eliminated by performing a power reset to the sensors 50. As shown in FIG. 8, in order to operate the sensors 50 (three shown in FIG. 8) a sensor power voltage Vcc is provided to pin 60a of the sensor elements 60. Pin 60b of the sensor element 60 is connected to a bipolar junction transistor 90 (model number ZTX689B), by connecting collector 91 of the transistor 90 to the pin 60b. Base 92 of the transistor 90 is connected to a switching control 93 which provides a pulsed control signal to the base 92 so that the transistor is switched on by a voltage Vcc for a period of 2 ms and then switched off by grounding the base 92 or providing a ground potential to the base 92 from the switching control 93. The sensor power supply 95 provides a continuous voltage Vcc to the pin 60a for powering the sensor elements 60.

When the transistor 90 is turned on by the voltage VCC from the switching control 93 the transistor 90 become conducting so that the pins 60b are connected to earth through emitter 94 of the transistor 90. Thus, a potential is applied across pin 60a and 60b so that the sensor elements 60 will be powered up because a positive potential is applied across the pin 60a and the pin 60b for a period of 2 ms when the high signal Vcc is supplied to the base 92 of the transistor 90. When the base 92 goes low by virtue of the switching control 93 supplying the low signal or ground potential, the transistor 90 is turned off thereby disconnecting. the pin 60b from ground and thereby electrically disconnecting the sensor elements 60 from ground. Thus, the sensor elements 60 are powered off. The sensor elements 60 are effectively turned off and are power reset when the ground potential is supplied to the base 92 from the switching control 93. Thus, any hysteresis due to the different operate and release points of the sensing element 60 is eliminated during the power reset so that hysteresis does not interfere with the accuracy of the detection of the magnets 22 during operation of the sensor assemblies 15 and 16.

FIG. 9 is a flow chart showing operation of the circuit of FIG. 8. As shown in FIG. 9, prior to the start of a computation cycle, power is supplied to the sensors by switching on the transistor 90 to power on the sensor elements 60 for 2 ms (step 901) to allow power supply to stabilise. At the end of the 2 ms period the status of the sensor elements 60 is read to determine whether the sensor elements 60 is detecting any magnetic field (step 902). The transistor 90 is turned off after the sensor elements 60 are read in (step 903). A determination of whether any sensor elements 60 has been activated is then performed and if the answer is no the system returns back to step 901. If the answer is yes a marker position is calculated at step 905 and an output is produced indicative of the marker position at step 906.

The switching transistor is pulsed on and off for 2 ms every 8 ms as shown in FIG. 8 continuously during operation of the central assemblies 15 and 16. The 2 ms period referred to above allows the power supply to the sensor elements 60 to stabilise and following that stabilisation the system will perform a snap shot to capture the status of all of the sensor elements 60. Once completed, the sensor elements 60 are switched off (i.e. in reset state) and the processor will start to compute the position of the magnet marker 22 if a magnet is detected by the sensors 15-16.

As the switching time of the transistor 90 is typically less than 1 ms and because of the high operating speed of 100 khz for the solid state magnetic sensor element, the 2 ms settling time for the system is sufficient to enable reset and reading of any detected magnetic field, whilst at the same time eliminating the problem of hysteresis of the sensor elements 60 and rely on only a single triggering point.

FIG. 8A shows an alternative arrangement to that shown in FIG. 8. In the arrangement of FIG. 8A the switching transistor is located between the power supply voltage VCC and pin 60a of the sensor elements 50. The switching control 93 supplies the intermittent pulse to the transistor 90 to selectively disconnect the power supply voltage VCC from pin 60a to intermittently power on and power off the sensor elements 60 shown in FIG. 8A.

Rather than use a magnetic sensor with a pin arrangement as shown in FIGS. 8 and 8A which includes three pins (namely the VCC pin, the ground pin and an output pin), the sensors could utilise four pins comprised of a VCC pin, ground pin, a first output pin and a second output pin for providing two outputs of different electrical characteristics (eg NPN and PNP types) or a four pin sensor having a VCC pin, ground pin, a +VO pin and a −VO pin to provide a range of voltage outputs corresponding to the strength of the magnetic field.

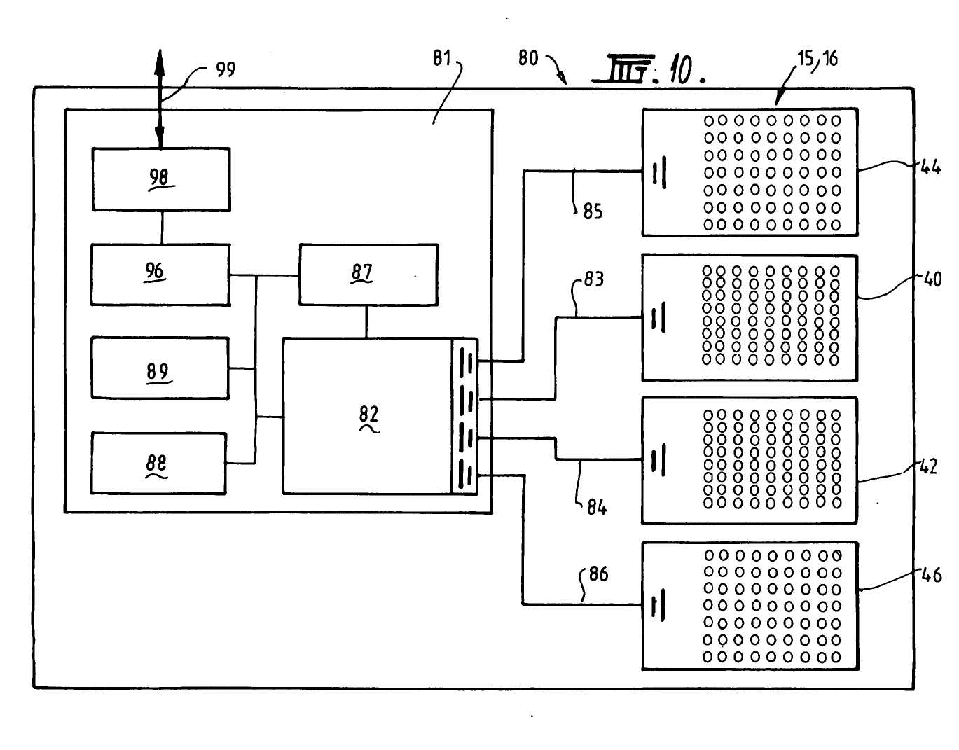

FIG. 10 shows a block diagram of the magnetic sensor module that makes up the assemblies 15 (or 16). The module 80 comprises a processor board 81 and the four sensor arrays 40, 42, 44 and 46. The processor board 81 contains the basic building blocks that made up the entire processing circuit. These building blocks include a micro-controller 96, ram access memory 88, erasable programmable random access memory 89, address decoding circuit 87 and digital input interface 82 to the sensor arrays. The software program that executes the detection algorithm is stored in the erasable programmable random access memory 89. The digital input interface 82 has four inputs connected respectively to each of the arrays 40, 42, 44 and 46 by lines 83, 84, 85 and 86. A RS 422 driver 98 is connected to micro-controller 96 to provide an external serial interface 99 for connection to the position estimator 26 shown in FIG. 2.

A detection algorithm for detecting the magnets utilises three techniques for computing the magnet position. The selection of these techniques depends on the pattern of the sensor activation in which, in turn, is governed by the position of the magnet under the sensor array. When used together, the system is able to detect markers occurring even at the sensor boundaries. This will effectively offer wider sensor coverage without having to physically increase the number of the sensors used.

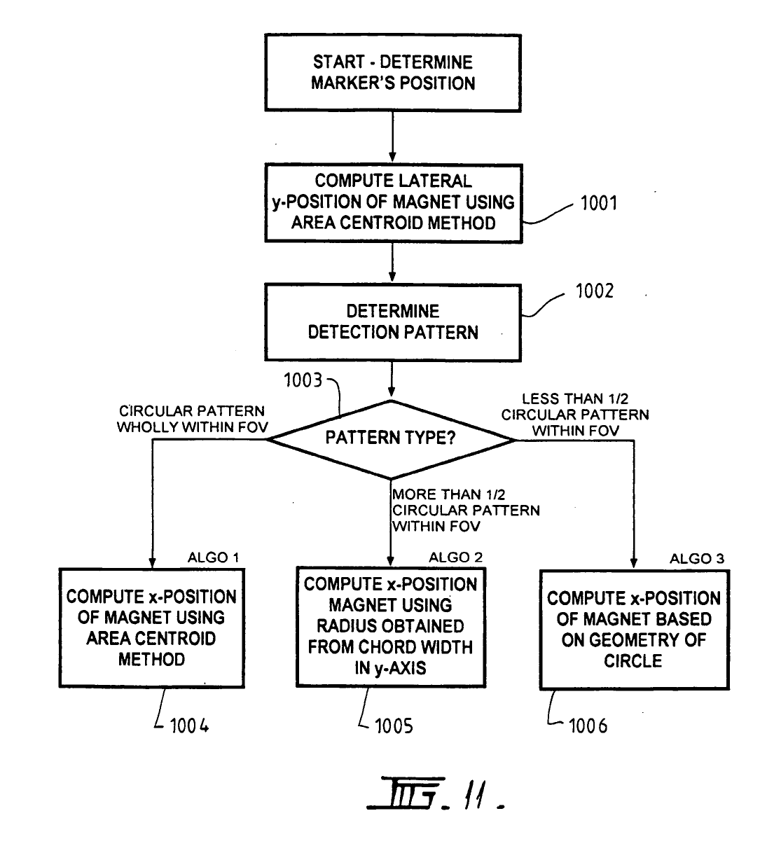

With reference to FIG. 11 which outlines the detection algorithm, the y position of the magnet is computed in step 1001 by using area moments as follows;

$$\overline{y} = \frac{{\sum }_{i = 1}^{M} [ {\sum }_{j = 1}^{N} ( {y}_{i , j} \cdot {s}_{i , j} ) ]}{{\sum }_{i = 1}^{M} [ {\sum }_{j = 1}^{N} ( {s}_{i , j} ) ]}$$

where

Sᵢⱼ =1 when the sensor element (i,j) is activated else 0,

Yᵢⱼ =y-coordinate of sensor element (i,j) with respect to sensor axis

M,N =Number of row and column sensor elements respectively

Note that the computation of the lateral y-position of the magnet for all positions whether partial or complete within the sensor coverage is accurately given by the area moment method. Since the pattern is symmetrical about the cental axis (parallel to the x-axis) through the pattern.

The determination of the longitudinal x-position of the magnet depends on the extent to which the circular pattern is within the sensor coverage (steps 1002 and 1003). If the detected circular pattern is wholly within the sensor coverage as shown in FIG. 12, step 1004 is implemented as follows;

$$\overline{x} = \frac{{\sum }_{i = 1}^{M} [ {\sum }_{j = 1}^{N} ( {x}_{i , j} \cdot {s}_{i , j} ) ]}{{\sum }_{i = 1}^{M} [ {\sum }_{j = 1}^{N} ( {s}_{i , j} ) ]}$$

where

Sᵢⱼ =1 when the sensor element (i,j) is activated else 0,

Xᵢⱼ =x-coordinate of sensor element (i,j) with respect to sensor axis

M,N =Number of row and column sensor elements respectively.

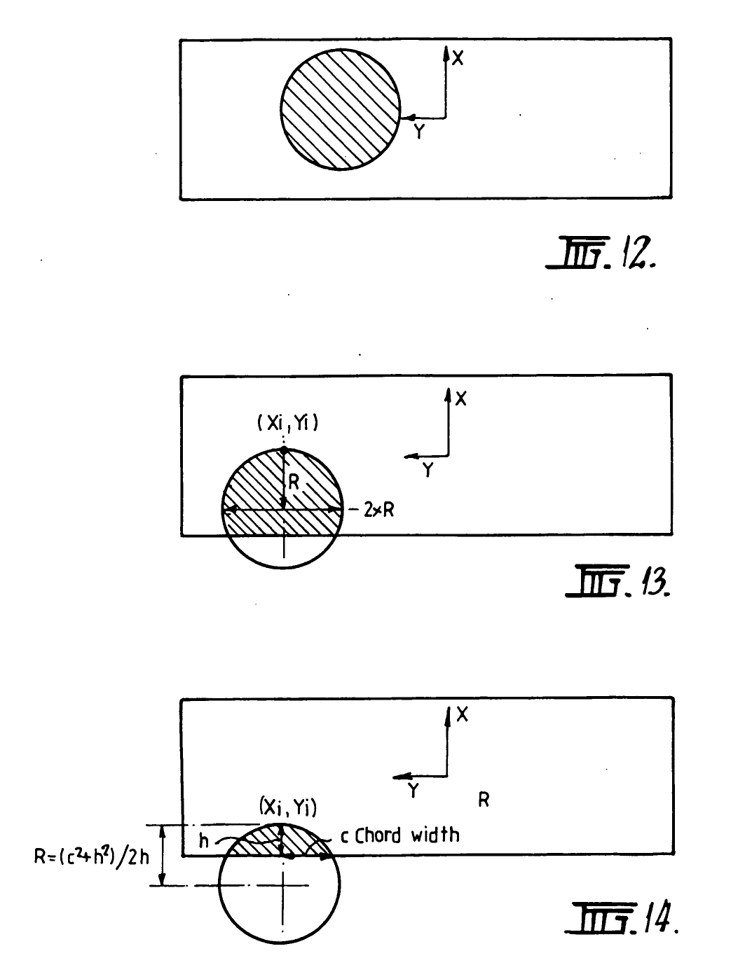

If an edge detection with more than half the circular pattern within the sensor coverage as shown in FIG. 13, the x position of the magnet is computed as per step 1005 as follows;

(a) Determine the diameter of the circular detected pattern by scanning row-wise for the maximum chord width.

(b) Obtain the radius, R, as half the diameter.

(c) Determine the tip (Xᵢ,Yᵢ) of the circle.

(d) The x-position of the magnet is simply given by [X_{I}-R].

If an edge detection was less than half the circular pattern as shown in FIG. 14, within the sensor coverage is detected as per step 1006, the x position of the magnet is computed in the following order;

(a) Determine the chord width, c, of the circular detected pattern at the edge of the sensor coverage.

(b) Determine the tip (X_{I},Y_{I}) of the circle.

(c) Determine the vertical height, h, from the tip of circle to the edge of the sensor coverage.

(d) The radius, R, of the detected circle is estimated by the geometrical formula:

$$R = \frac{{c}^{2} + {h}^{2}}{2 h}$$

(e) The x position of the magnet is then given by [X_{I}-R].

The assembly shown in FIG. 10 is housed in a sensor box (not shown) made from 3 mm thick aluminium sheet. The box must be constructed of a non-ferrous material so that it is transparent to magnetic flux.

The preferred embodiment of the invention in that the assemblies 15 and 16 can be mounted at higher heights, say, 25 cm instead of 10 cm, above the ground. This will greatly minimise the chances of the sensors being damaged by foreign protruding objects on the ground, and due to type puncture and wear. This also eases the requirements on the vehicle suspension and allows for larger height variations between the sensor and ground magnets.

Furthermore, smaller and thinner magnets can be used in the preferred embodiment of the invention. This leads to substantial cost savings in the installation of the magnets and the costs of the magnet markers. It also eases the constraint on the allowable thickness of the magnets due to the reinforcement bars in the concrete. Furtherstill, the problem of inaccurate detection of the exact magnet position due to hysteresis is totally eliminated. The system is able to provide accurate measurements of the magnet position according to the sensor specifications ie. half the separation between the magnetic sensors.

Since modifications within the spirit and scope of the invention may readily be effected by persons skilled within the art, it is to be understood that this invention is not limited to the particular embodiment described by way of example hereinabove.

The claims defining the invention are as follows:

1. A magnetic field sensor assembly for sensing a magnetic field created by a magnet, the sensor assembly including;
at least one sensor having a sensor element; and
a magnetisable member located adjacent the sensor element and between the sensor element and the magnet when the sensor is in use, and wherein, in use, the member becomes magnetised by the magnetic field produced by the magnet to create a secondary magnetic field which is detected by the sensor element to thereby boost or increase the localised magnetic flux density produced by the magnet.

2. The assembly of claim 1 wherein the member is a cylindrical rod shaped member having a longitudinal axis which is aligned, in use, in the direction of a line extending between the magnet and the sensor when the sensor passes the magnet.

3. The assembly of claim 1 or 2 wherein the member is a ferromagnetic member.

4. The assembly of claim 3 wherein the member is formed from manganese zinc ferrite material having the general formula MnZn.Fe₂O₃ .

5. The assembly of claim 1 wherein the member is impinged against the sensor element.

6. The assembly of claim 1 the member has a diameter of about 8 mm and a length of about 40 mm and an initial permeability of 2000.

7. The assembly of claim 1 wherein the sensor element is mounted on a sensor board and the member is located in a member holder, a spring being located in the member holder for biasing the member so that it impinges against the sensor element.

8. The assembly of claim 7 wherein the member holder is coupled to a holder plate, the holder plate having a screw threaded hole and the member holder having a screw thread for engagement in the screw threaded hole, the sensor board being located adjacent to the holder plate so that the sensor element projects through the screw threaded hole and into the member holder.

9. The assembly of claim 8 wherein the member holder has a base and the spring is disposed between the base and the member for biasing the member against the sensor element.

10. The assembly of claim 8 wherein the member holder has a circumferential flange for engaging a surface of the member plate for limiting the amount of insertion of the member holder into the screw threaded hole when the member holder is screw threaded into the screw threaded hole in the member plate.

11. The assembly of claim 1 wherein the sensor comprises a plurality of said sensor elements and said magnetisable members.

12. An automated guided vehicle system, including;
at least one automated guided vehicle, the automated guided vehicle having a sensor assembly having at least one sensor, the sensor including a plurality of sensor elements each sensor element having a magnetisable member located adjacent the sensor element;
a plurality of magnets arranged along a roadway which is to be traversed by the vehicle for guiding movement of the vehicle along the roadway;
each sensor element having the magnetisable member located adjacent the sensor element so as to be between the sensor element and the magnets when the vehicle passes over the magnets; and
wherein when the vehicle passes over the magnets the member becomes magnetised by the magnetic field produced by the magnets to create a secondary magnetic field which is detected by the sensor element to thereby boost or increase the localised magnetic flux density produced by the magnets.

13. The system of claim 12 wherein the member is a cylindrical rod shaped member having a longitudinal axis which is aligned, in use, in the direction of a line extending between the magnets and the sensor when the sensor passes over the magnet.

14. The system of claim 12 or 13 wherein the magnetisable member is a ferromagnetic member.

15. The system of claim 14 wherein the member is formed from manganese zinc ferrite material having the general formula MnZn.Fe₂O₃ .

16. The system of claim 12 wherein the member is impinged against the sensing element.

17. The system of claim 12 wherein the member has a diameter of about 8 mm and a length of about 40 mm and an initial permeability of 2000.

18. The system of claim 12 wherein the sensor element is mounted on a sensor board and the member is located in a member holder, a spring being located in the member holder for biasing the member so that it impinges against the sensor element.

19. The system of claim 18 wherein the member holder is coupled to a holder plate, the holder plate having a screw threaded hole and the member holder having a screw thread for engagement in the screw threaded hole, the sensor board being located adjacent to the holder plate so that the sensor element projects through the screw threaded hole and into the member holder.

20. The system of claim 19 wherein the member holder has a base and the spring is disposed between the base and the member for biasing the member against the sensor element.

21. The system of claim 20 wherein the magnets are ceramic-ferrite magnets of cylindrical shape and have a diameter of about 100 mm and a length of about 50 mm.

22. A magnetic field sensor assembly sensing a magnetic field created by a magnet for the sensor assembly including;
at least one sensor element for detecting the magnetic field produced by the magnet; and
power switching means for selectively switching the sensor elements between a power on level and a power off level.

23. The assembly of claim 22 wherein the power switching means comprises a transistor and switching control means for switching the transistor on and off, the transistor having a collector which is connected to the sensor element and an emitter which is connected to ground, the switching control means being connected to the base of the transistor so that when a power on signal is applied to the base the sensor element is connected to ground through the transistor and the sensor element is activated or powered up since potential can be applied across the sensor element between the ground created by the transistor and a sensor power supply to the sensor element, and when the switching control means switches off the transistor, the transistor is switched off to disconnect the sensor element from ground so that there is no potential difference across the sensor element and the sensor element is powered off.

24. The assembly of claim 23 wherein the switching control means switches the sensor elements on and off periodically by supplying high and low signals to turn on and off the transistor.

25. The assembly of claim 24 wherein the sensors are powered on for about 2 ms, then read, and then powered off for at least 1 ms and then powered on again for 2 ms and so on.

26. The assembly of claim 23 wherein the sensor power supply comprises a fixed voltage supplied to the sensor elements.

27. The assembly of claim 22 wherein each sensor element has a ferromagnetic member located adjacent the sensor element for boosting or increasing a localised magnetic field strength produced by the magnets.

28. An automated guided vehicle system, including;
at least one vehicle including a magnetic field sensor assembly having at least one sensor element;
a plurality of magnets located along a roadway for guiding movement of the vehicle relative to the magnets; and
switching means for periodically switching power on and off to the at least one sensor element.

29. The system of claim 28 wherein the power switch means comprises a transistor and switching control means for switching the transistor on and off, the transistor having a collector which is connected to the sensor element and an emitter which is connected to ground, the switching control means being connected to the base of the transistor so that when a power on signal is applied to the base the sensor element is connected to ground through the transistor and the sensor element is activated or powered up since potential can be applied across the sensor element between the ground created by the transistor and a sensor power supply to the sensor element, and when the switching control means switches off the transistor, the transistor is switched off to disconnect the sensor element from ground so that there is no potential difference across the sensor element and the sensor element is powered off.

30. The system of claim 29 wherein the switching control means switches the sensor elements on and off periodically by supplying high and low signals to turn on and off the transistor.

31. The system of claim 30 wherein the sensors are powered on for about 2 ms, then read, and then powered off for at least 1 ms and so on.

32. The system of claim 29 wherein the sensor power supply comprises a fixed voltage supplied to the sensor elements.

33. The system of claim 28 wherein each sensor element has a ferromagnetic member located adjacent the sensor element for boosting or increasing a localised magnetic flux density produced by the magnets.

34. A sensor assembly for detecting a magnetic field produced by a magnet, including;
at least one sensor element having first and second power pins and an output pin;
a sensor power supply for supplying power to the first pin of the at least one sensor element, the second pin of the at least one sensor element being coupleable to a reference potential so that power is supplied to the at least on sensor element for powering the at least one sensor element;
switching means for selectively powering on or off the at least one sensor element; and
a switching control means for providing a pulsed power signal to the switching means to cause the switching means to intermittently switch power on and off to the at least one sensor element to perform a power reset to the at least one sensor element to eliminate hysteresis within the at least one sensor element.

35. The assembly of claim 34 wherein the switching means is between the second pin and reference potential for disconnecting the second pin from the reference potential to power the at least one sensor element off, and wherein when the pulsed power signal is supplied to the switching means the switching means is caused to intermittingly disconnect the second pin from the reference voltage so that the at least one sensor element is intermittently powered on and off to perform the power reset.

36. The assembly of claim 34 wherein the switching means is between the first pin and the sensor power supply for disconnecting the first pin from the sensor power supply to power the at least one sensor element off, and wherein when the pulsed power signal is supplied to the switching means the switching means is caused to intermittently disconnect the first pin from the sensor power supply so that the at least one sensor element is intermittently powered on and off to perform the power reset.

37. The assembly of claim 36 wherein the switching means comprises a transistor.

38. The assembly of claim 35 wherein the switching means comprises a transistor having a base, a collector and an emitter, the collector being connected to the second pin, the emitter being connected to the reference potential and the base being connected to the switching control means.

39. The assembly of claim 35 wherein the reference potential is ground.

40. The assembly of claim 35 wherein the switching control means supplies a pulse signal having a high signal for switching the transistor on and therefore connecting the second pin to the reference potential for a period of about 2 ms, and a low signal for switching the transistor off and therefore disconnecting the second pin from the reference potential.

41. The system of claim 34 wherein the sensor element has a magnetisable member adjacent the sensor element which becomes magnetised by a magnetic field produced by the magnet to increase the localised magnetic flux density for detection by the at least one sensor element.

42. An automated vehicle guidance system for automatically guiding a vehicle relative to a plurality of magnets, said system including;
at least one vehicle including at least one magnetic field sensor assembly;
a plurality of magnets arranged along a roadway which the vehicle is to traverse;
the sensor assembly having;
at least one sensor element having first and second power pins and an output pin;
a sensor power supply for supplying power to the first pin of the at least one sensor element, the second pin of the at least one sensor element being coupleable to a reference potential so that power is supplied to the at least on sensor element for powering the at least one sensor element;
switching means for selectively powering on and off the at least one sensor element; and
a switching control means for providing a pulsed power signal to the switching means to cause the switching means to intermittently switch power on and off to the at least one sensor element to perform a power reset to the at least one sensor element to eliminate hysteresis within the at least one sensor element.

43. The system of claim 42 wherein the switching means is between the second pin and reference potential for disconnecting the second pin from the reference potential to power the at least one sensor element off, and wherein when the pulsed power signal is supplied to the switching means the switching means is caused to intermittingly disconnect the second pin from the reference voltage so that the at least one sensor element is intermittently powered on and off to perform the power reset.

44. The system of claim 42 wherein the switching means is between the first pin and the sensor power supply for disconnecting the first pin from the sensor power supply to power the at least one sensor element off, and wherein when the pulsed power signal is supplied to the switching means the switching means is caused to intermittently disconnect the first pin from the sensor power supply so that the at least one sensor element is intermittently powered on and off to perform the power reset.

45. The system of claim 44 wherein the switching means comprises a transistor.

46. The system of claim 42 wherein the switching means comprises a transistor having a base, a collector and an emitter, the collector being connected to the second pin, the emitter being connected to the reference potential and the base being connected to the switching control means.

47. The system of claim 43 wherein the reference potential is ground.

48. The system of claim 43 wherein the switching control means supplies a pulse signal having a high signal for switching the transistor on and therefore connecting the second pin to the reference potential for a period of about 2 ms, and a low signal for switching the transistor off and therefore disconnecting the second pin from the reference potential.

49. The system of claim 42 wherein the sensor element has a magnetisable member adjacent the sensor element which becomes magnetised by a magnetic field produced by the magnet to increase the localised magnetic field strength for detection by the at least one sensor element.

50. A magnetic field sensor assembly for detecting a, magnetic field created by a magnet, the sensor assembly including;
at least one central sensor array, the central sensor array having a plurality of sensors spaced apart by a predetermined first distance; and
a first side sensor array and a second side sensor array arranged on each side of the central sensor array so as to sandwich the central sensor array therebetween, the first and second side sensor arrays each having a plurality of sensors spaced apart by a second predetermined distance which is greater than the first predetermined distance.

51. The assembly of claim 50 wherein the central sensor array comprises a first central sensor array and a second central sensor array.

52. The assembly of claim 50 wherein the first and second sensor arrays each comprise nine rows and eight columns of magnetic sensor elements.

53. The assembly of claim 50 wherein the first and second side sensor array also each comprise nine rows and eight columns of magnetic sensor elements.

54. The assembly of claim 50 wherein each of the sensor arrays are coupled to a processor board for receiving output signals from each sensor array to enable the position of a vehicle to be determined relative to the magnets.

55. The assembly of claim 54 wherein the processor board is coupleable to a navigation system for determining the position of a vehicle relative to the magnets and for producing control signals for controlling movement of the vehicle in response to the position signals.

56. The assembly of claim 50 wherein the sensors each comprise a sensor element and a magnetisable member adjacent the sensor element.

57. An automated guided vehicle system, including;
at least one vehicle including a sensor assembly;
a plurality of magnets located along a roadway for detection by the sensor to enable the vehicle to be automatically guided relative to the magnets; and
wherein the sensor assembly comprises at least one central sensor array, the central sensor array having a plurality of sensor elements spaced apart by a predetermined first distance, and a first side sensor array and a second side sensor array arranged on each side of the central sensor array so as to sandwich the central sensor array therebetween, the first and second side sensor arrays each having a plurality of sensors spaced apart by a second predetermined distance which is greater than the first predetermined distance.

58. The system of claim 57 wherein the central sensor array comprises a first central sensor array and a second central sensor array.

59. The system of claim 57 wherein the first and second sensor arrays each comprise nine rows and eight columns of magnetic sensor elements.

60. The system of claim 57 wherein the first and second side sensor array also each comprise nine rows and eight columns of magnetic sensor elements.

61. The system of claim 57 wherein each of the sensor arrays are coupled to a processor board for receiving output signals from each sensor array to enable the position of a vehicle to be determined relative to the magnets.

62. The system of claim 61 wherein the processor board is coupleable to a navigation system for determining the position of a vehicle relative to the magnets and for producing control signals for controlling movement of the vehicle in response to the position signals.

63. The system of claim 61 wherein the sensors each comprise a sensor element and a magnetisable member adjacent the sensor element.
